(19) United States
(12) Patent Application Publication
(10) Pub. No.: US 2012/0096292 A1
(43) Pub. Date: Apr. 19, 2012

(54) METHOD, SYSTEM AND APPARATUS FOR MULTI-LEVEL PROCESSING

(75) Inventor: Nagi MEKHIEL, Markham (CA)

(73) Assignee: MOSAID TECHNOLOGIES INCORPORATED, Ottawa (CA)

(21) Appl. No.: 13/239,977

(22) Filed: Sep. 22, 2011

Related U.S. Application Data
(60) Provisional application No. 61/393,531, filed on Oct. 15, 2010.

(51) Int. Cl. G06F 1/12; G06F 9/30; G06F 1/04

(52) U.S. Cl. 713/322; 713/375; 713/401; 713/600; 712/31; 712/E09.023; 712/E09.016

(57) ABSTRACT

A Multi-Level Processor 200 for reducing the cost of synchronization overhead including an upper level processor 201 for taking control and issuing the right to use shared data and to enter critical sections directly to each of a plurality of lower level processors 202, 203 . . . 20n at processor speed. In one embodiment the instruction registers of lower level parallel processors are mapped to the data memory of upper level processor 201. Another embodiment 1300 incorporates three levels of processors. The method includes mapping the instructions of lower level processors into the memory of an upper level processor and controlling the operation of lower level processors. A variant of the method and apparatus facilitates the execution of Single Instruction Multiple Data (SIMD) and single to multiple instruction and multiple data (SI>MIMD). The processor includes the ability to stretch the clock frequency to reduce power consumption.

### FIELD OF THE INVENTION

The present invention relates to computer data processing and in particular to a multi-processor data processing. With still greater particularity the invention relates to apparatus, methods, and systems for synchronizing multi-level processors.

### BACKGROUND OF THE INVENTION

The power of a single microprocessor has seen continued growth in capacity, speed and complexity due to improvements in technology and architectures until recently. This improvement has of late reached a diminishing return. The performance of single processor has started to reach its limit due to the growing memory/processor speed gap and a delay due to the conductors inside the chip. This is combined with a slowdown in clock speed rate increase due to power and thermal management limitations brought about by higher component density.

Although the performance of single processor is reaching its limit, the need for computing power is growing due to new multimedia applications, increasingly sophisticated digital signal processing, scientific applications such as modeling of weather, and other engineering applications for designing complicated systems using CAD tools.

Although technology is still improving, producing more transistors per chip at higher speed the architecture of single processor cannot continue to effectively utilize these improvements. The result has been for the industry to switch to multi-core in a single chip. Industry recently has produced two, four, and eight cores in a single chip and users are expecting to obtain proportional gain in performance. In addition, with Multiprocessor systems on a single chip, parallel processing that has until recently, being out of reach to many is now available at an affordable cost.

The performance gain of multiprocessor systems is also limited by fundamental problems mainly due to synchronization and communication overheads. Prior attempts to solve the synchronization problem have had limited success. Parallel processors must divide the applications into processes that can be executed concurrently sharing data and communicate between each other using a network and memory. The sharing of data is usually serialized in time using mutual exclusion.

Amdahl's Law is often used in parallel computing to predict the theoretical maximum speedup available by using multiple processors. The speedup of a program using multiple processors in parallel computing is limited by the time needed for the sequential fraction of the program. For example, if a program needs 20 hours using a single processor core, and a particular portion of 1 hour cannot be parallelized, while the remaining promising portion of 19 hours (95%) can be parallelized, then regardless of how many processors we devote to a parallelized execution of this program, the minimum execution time cannot be less than that critical 1 hour. Hence the speed up is limited up to 20×.

It has been stated that the most optimistic outcome, of course, is that someone figures out how to make dependable parallel software that works efficiently as the number of cores increases. That will provide the much-needed foundation for building the microprocessor hardware of the next 30 years. Even if the routine doubling every year or two of the number of transistors per chip were to stop—the dreaded end of Moore's Law—innovative packaging might allow economical systems to be created from multiple chips, sustaining the performance gains that consumers have long enjoyed.

Synchronization is implemented in multiprocessor systems using special atomic instructions that allow each processor to acquire a special memory location called lock before it has the right to use a shared data item or enter a critical code section. This involves using the network or a bus for all N processors competing to acquire the lock and wait for all other processors. While waiting, the processors spin in a tight loop wasting time and power. Each time a processor acquires the lock it must release it when it finishes. It involves an invalidation of lock location using the bus or the network for acquiring and releasing each lock.

The time cost of synchronization for a 32-processor in SGI Origin 3000 system is that it takes 232,000 cycles during which the 32 processors could have executed 22 million FLOPS and which is a clear indication that conventional synchronization hurt system performance. The impact of locks on the scalability of conventional multiprocessor that uses a network outside the chip for snooping scales only to about 6 for using 8 processors, however the scalability drops to 1 when using 32 processors. Multiprocessor with a fast network inside the chip scales only to about 12 when using 32 processors.

Conventional multicore processors use special atomic instructions as load-linked followed by store conditional instructions for synchronization. The LL (load-linked) instruction loads a block of data into the cache, then a subsequent store conditional (SC) instruction attempts to write to the same block. It succeeds only if the block has not been referenced since the preceding LL. Any reference to the block from another processor between the LL and SC pair causes the SC to fail. The synchronization cost for this is a latency of using the bus or network plus each time a processor fails, it must use the bus to load the block from the cache (because of the invalidation) repeatedly while spinning around in a tight loop waiting for a successful SC and wasting time and power.

One approach to solve this problem has been the Research Accelerator for Multiple Processors (RAMP) research project. RAMP proposes the use of Field Programmable Gate Arrays (FPGAs) to build a large scale Massive Parallel Processor (MPP) (up to 1000 processors) in an attempt to develop effective software for large scale parallel computers. A problem with this method is that it emulates the large scale multiprocessor system but does not accurately represent its behavior. For example, when RAMP uses real processors, then processor memory speed ratio becomes very large, causing limitations to performance gain of huge number of processors and needs to hide the large latency of memory gap. FPGA emulation achieves less than 100 times slowdown relative to a real system. Therefore it cannot be used for a real large scale parallel processing system.

Transactional Memory (TM) was developed as another attempt to improve parallel processing performance Transactional memory attempts to reduce synchronization overhead by executing transaction of large code without locks, atomically. If the transaction fails, it will not commit and overhead of supporting it is wasted. A key challenge with transactional memory systems is reducing the overheads of enforcing the atomicity, consistency, and isolation properties. Hardware TM limitations are due to hardware buffering forcing the system into a spill state in lower levels of memory hierarchy. Software TM have additional limitations when caused to manipulate metadata to track read and write sets, the additional instructions, when executed increase the overhead in memory system and power consumption.

Neither method mentioned above, deal effectively with the scalability problem, RAMP slows down processors to hide the huge memory latency that a real fast processor would need thousands of parallel instructions to execute. TM restricts a large chunk of code to run in parallel and depends on having concurrency among transactions, thus preventing fine grain parallelism, making system performance limited to performance of slowest transaction.

Recently researchers have proposed an Asymmetric Chip Multiprocessor (ACM) to improve the performance of the serial part of parallel applications and also the critical sections rather than using locks for each processor to run the code in the critical section, individual processors send a request for a large core (special powerful processor) to run the critical section and then the requesting processor can resume execution. This method requires additional overhead to send and receive messages from each processor to the large core processor. Data and code in the critical section must be transferred to the large processor using a bus adding extra overhead. This method can only run the code of one critical section at a time in serial fashion, and cannot allow multiple concurrent groups of processors to run in their critical sections even if they are different. All processors compete together to obtain the right to use the large processor, thus only one processor at a time is successful and the others must wait.

The improvements due to ACM come mainly because the large processor is faster than all the processors and it can speed up the serial code. A limitation is the larger processor consumes more power and costs more in terms of silicon to implement. Another limitation in ACM is that when all other processors use the large processor to execute their serial code, the cache of the large processor stores codes and data from different program areas that lack spatial localities, causing an increase in cache miss rate due to evictions.

Conventional multiprocessor systems use locks to synchronize between different processors when they try to access shared data or enter into critical code section. Each shared data item or critical section uses a memory location called lock that must be acquired by swapping a content of a register that is set tot with the content of the lock, if the register returns zero then the lock is free and the processor atomically sets the lock to 1 using the value of the register. If the swap returns a 1 in the register, then the lock is being used by another processor and the processor has to spin in a loop waiting for a successful swap.

The following is a code for synchronization in conventional multiprocessor:
R=1; • set the value of processor register R to 1
Loop: EXCHANGE (R, LOCK); • swap register with lock
If R==1 then goto Loop; • wait in a loop if lock value returns a 1
{enter critical section}; • else start execute code in critical section
Lock=0; • when finish set lock=0 for other processors to enter critical section

In the above code each processor needs to use the bus or network to write to the lock because the lock is a shared variable and must be updated or invalidated in other processor's caches. The processor must use the network when it finishes from executing the code in critical section and writes zero to the lock. This requires the processor to use the bus or network one more time, and for N processors, the spent will be:

2N+1+2(N−1)+ . . . 2+1 which is:

Sum of (2i+1) from i=0 to N=2N+N×N bus cycles.

The above formula gives the worst condition. The best condition is 2N bus cycles.

FIG. 1 is a block diagram 100 showing three processors trying to acquire a shared variable using a bus at time T0. The processor PN is the first processor to acquire the lock at T0 while P1, P0 are waiting. PN releases the lock at T1, immediately P1 acquires the lock while P0 is waiting. At time T2 P1 releases the lock and P0 finally acquires the lock. This example represents the best possible condition which is 2N.

### SUMMARY OF THE INVENTION

Multi-Level Processing as described herein reduces the cost of synchronization overhead by having an upper level processor take control and issue the right to use shared data or enter critical section directly to each processor at the processor speed without the need for each processor to be involved in synchronization. The instruction registers of lower level parallel processors are mapped to the upper level processor data memory without copying or transferring thus enabling the upper level processor to read each parallel processor's instruction and change it without any involvement or awareness from low level parallel processors. A system using Multi Level Processing as described reduces synchronization waiting time for a 32 conventional multiprocessor system using a 100 cycle bus from 32×32×100 cycle to only 32×1 cycle offering a gain of 3200 times. In addition, the system allows concurrent accessing of different shared data items and the ability to halt each processor to reduce power while waiting for the right to access shared data. The described embodiments offer an easy way to support vector operations using effective implementation to SIMD. The system makes parallel programming simpler for programmers by having a higher level processor generate parallel code from sequential code which reduces bandwidth requirements for instruction fetch. When lower level processors are used as synchronizing processors to yet another lower level parallel processors, the system will offer unlimited scalability for multiprocessors.

### BRIEF DESCRIPTION OF THE DRAWINGS

Features and advantages of the present invention will become apparent from the following detailed description, taken in combination with the appended drawings for clarity. In the figures only three processors are shown on the lower level but it is appreciated that the actual number will far exceed three.

FIG. 1 is a block diagram of three conventional processors trying to acquire a shared variable using a bus;

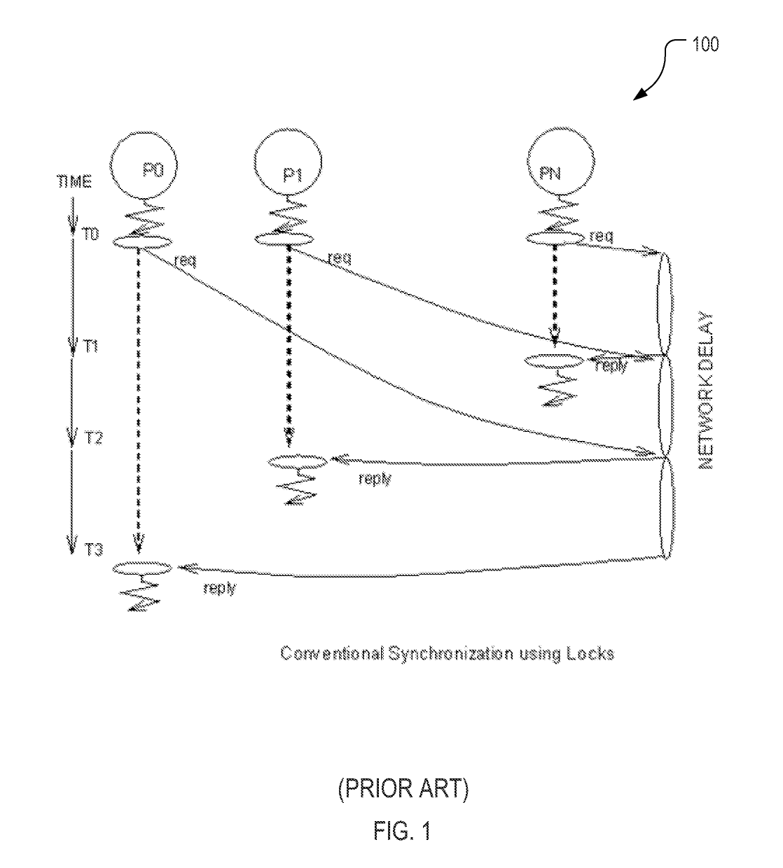

FIG. 2 is a block diagram of a system incorporating an embodiment of the invention;

FIG. 3 is a block diagram illustrating another aspect of a system incorporating the FIG. 2 embodiment of the invention;

FIG. 4 is a block diagram for a system incorporating the FIG. 2 embodiment of the invention illustrating the Bus;

FIG. 5 is a schematic diagram of a detailed design of a portion of the FIG. 2 embodiment;

FIG. 6 is a block diagram of queues illustrating operation of the FIG. 2 embodiment;

FIG. 7 is a flowchart of a method incorporating the invention;

FIG. 8 is a block diagram of a another portion of the FIG. 2 embodiment of the invention;

FIG. 9 is a block diagram of another embodiment of the invention;

FIG. 10 is a block diagram of a portion of the FIG. 9 embodiment of the invention;

FIG. 11 is a block diagram of a third embodiment of the invention;

FIG. 12 is a block diagram of a fourth embodiment of the invention;

FIG. 13 is a block diagram of a fifth embodiment of the invention.

### DETAILED DESCRIPTION OF VARIOUS EMBODIMENTS

The following embodiments are focused on dealing with the fundamental problems of parallel processing including synchronization. It is desirable to have a solution that is suitable for current and future large scale parallel systems. The embodiments eliminate the need for locks and provide synchronization through the upper level processor. The upper level processor takes control of issuing the right to use shared data or enter critical section directly to each processor at the processor speed without the need for each processor to compete for one lock. The overhead of synchronization is reduced to one clock for the right to use shared data. Conventional synchronization with locks cost N² bus cycles compared to N processor cycles in the multi-level processing of the present invention. For a 32 conventional multiprocessor system using a 100 cycle bus, synchronization costs 32×32×100 cycle compared to only 32×1 cycle for multi-level processing offering a gain of 3200 times.

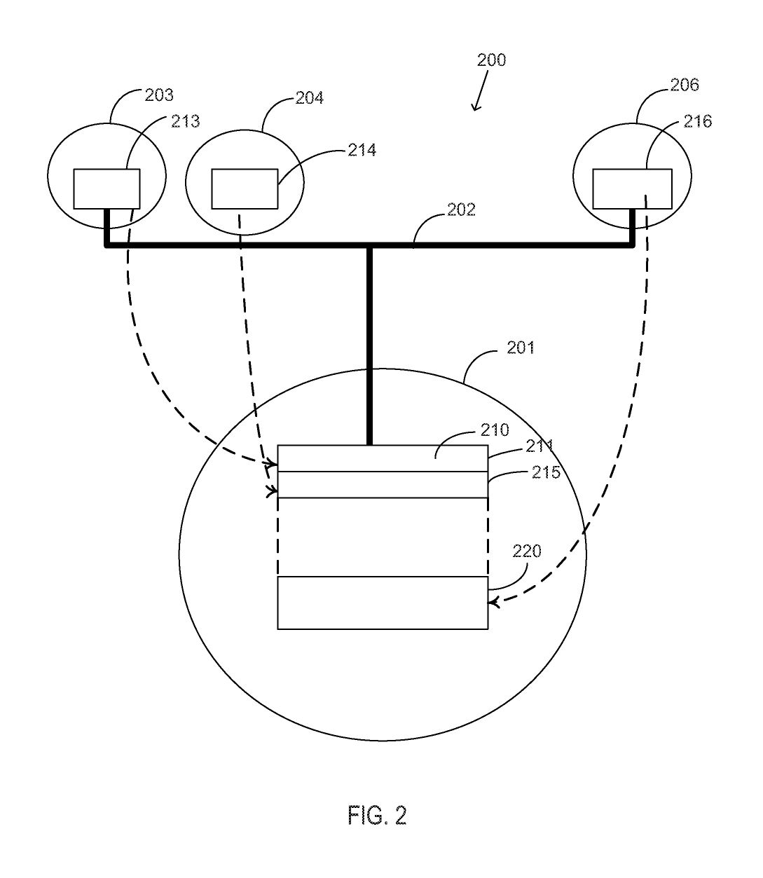

FIG. 2 is a block diagram of a system 200 incorporating an embodiment of the invention This embodiment uses a higher level processor 201, referred to hereinafter as SyncP or “Synchronizing Processor” which has the ability to view and monitor all of the instructions in the lower level processors by mapping their instruction registers into the higher level processor data memory without physically duplicating the registers or copying them or transferring these instructions to the higher level processor.

FIG. 2 illustrates how Multi-Level processor 201 (SyncP) maps all of the lower level processors instructions into its data memory 211 by using a dedicated bus 202 which enables SyncP 201 to access any instruction registers of a lower level processor as if it were its own memory. The first lower level processor 203 has its instruction register 213 mapped to SyncP 201 data memory location 210, the second lower level processor 204 register 214 maps to data memory location 215. In a similar manner all processors (not shown) map to a data memory location in 201. Finally, the last lower level processor 206 register 216 maps to data memory location 220.

Monitoring lower level processors 203, 204 through 206 instructions enables upper level processor 201 to control the instructions they execute and the time to execute them by injecting desired instructions into the lower level processors 203, 204 through 206 instruction registers 213, 214 through 216 at any time based on the synchronization requirements. The details of implementation for mapping different instruction registers 213, 214 through 216 of low level parallel processors 203, 204 through 206 into the data memory 211 of upper level SyncP 201 is given below in the implementation section. The lower level processor selected by SyncP 201 from lower level processors 203, 204 through 206 executes a halt instruction that causes it to stop executing and wait for SyncP 201 to take control of the execution by reading the lower level processor instruction then inserting the desired instruction.

SyncP 201 is also able to control the clock speed of each lower level processor 203, 204 through 206 to allow it to write and read reliably from their instruction registers by sending specific data code using SyncP bus 202 to the state machine that generates the clock or could map the clock control of each processor to SyncP 201 data memory. SyncP 201 writes to the data memory 211 a value that the state machine uses to generate the lower processor clock. It is important to note that this feature is not needed in multi-level processing synchronization because lower level processors 203, 204 through 206 use the halt instruction, giving SyncP 201 all the time it needs to read and write to instruction register mapped to 211. This clock generation feature is only for SIMD (Single Instruction Multiple Data) and SI>MIMD. A much simpler way to synchronize lower processor clock so that SyncP can read or write to the instruction registers of lower processors 203, 204 through 206 is possible and depends on technology and implementation.

This embodiment uses high level processor SyncP 201 to continuously monitor the instruction registers of lower level processors 203, 204 through 206 parallel processing by mapping the instructions to its data memory 211. The code for SynchP 201 is:
Loop: for (i=0 to N−1); • to all processors
load R, IRi; • read each instruction of lower processors
if ((R)==request to use X); • If instruction is a request to use shared variable X
store R2, IRi; • Assert right to use X by writing GRANT to IRi or wait
if ((R)==end of request); • If processor finishes from critical section code
store R3, IRi; • Assert a continue to execute normal code

This code runs only in SyncP 201, while the N lower level processors 203, 204 through 206 execute their code.

In the embodiment the synchronization code runs in the background without any involvement or awareness of lower level processors 203, 204 through 206. SyncP 201 is able to write directly to the requesting instruction and give it the right to enter a critical section, while the other low level processors 203, 204 through 206 requesting to use the same variable X wait. The request instruction stays in their instruction register through which the pipeline of processors 203, 204 through 206 is halted by stretching their clock cycle or by converting the instruction to a halt. The purpose of stretching the clock is to slow it down to save power. The details of halting instruction and stretching the processor clock are explained below in the power saving feature section.

When the processor selected from lower processors 203, 204 through 206 completes executing the code in critical section or finishes the use of shared variable X, it uses another instruction that has a halting capability for informing SyncP 201 of the end of requesting X. SyncP 201 when reads it, removes the halt instruction, and allows the one selected lower level processor of 203, 204 through 206 to continue executing the remainder of its code.

The time to serve all N requesting processors to use X is only in the order of N cycles.

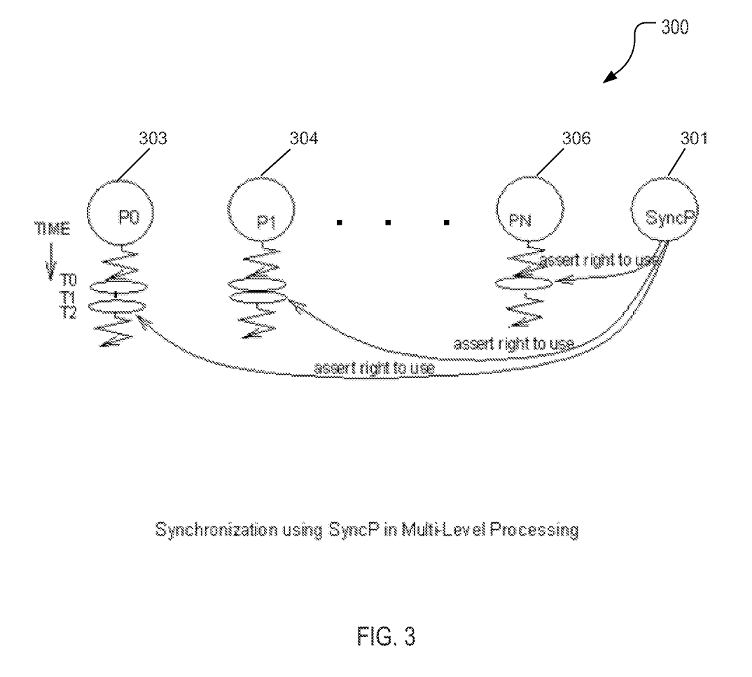

FIG. 3 is a diagram showing the method 300 SyncP 301 uses to assert right to use shared variables for PN 306, P1 304, and then P0 303 in 3 clock cycles.

It should be noted that the time spent on executing code in critical section is ignored in FIG. 3.

To calculate the gain in synchronization time achieved by this embodiment we assume the following:

Number of processors=10 and the Bus cycle time=10 processor cycles;

The conventional multiprocessor synchronization cost from 2N to 2N+N×N;

That is from 2×10×10=200 to (200+1000) cycles;

Multi-Level synchronization cost only N=10 cycles;

The gain range is 20 to 120 times.

Considering a large number of processors, and using a network of 100s cycles, the gain will be in 1000s fold. It is important to note that this gain is in synchronization time and not in overall performance.

The ability for high level processor 301 to read and write to the instructions of lower level processors 303, 304 through 306 has the following important advantages:

1. The reduction of power as each processor 303, 304 through 306 need not to spin waiting for the lock to be released. Each lower level processor 303, 304 through 306 uses a halt instruction or stretches its clock.

2. SyncP 301 monitors all instructions in lower level processor 303, 304 through 306 and therefore can concurrently issue the right to use more than one shared variable at the same time. Conventional multiprocessors on the other hand rely on a shared bus to support synchronization with atomic operations that cannot be interrupted by other read or write instructions from other processors.

3. SyncP 301 can insert one instruction for all lower level processors 303, 304 through 306, thus implementing a simple and effective SIMD to support vector operations.

4. SyncP 301 can write an indirect data to all low level instructions such that each processor 303, 304 through 306 will use one field of the data to index a microcode ROM to execute different instruction without the need for each processor to fetch any instructions from cache or memory.

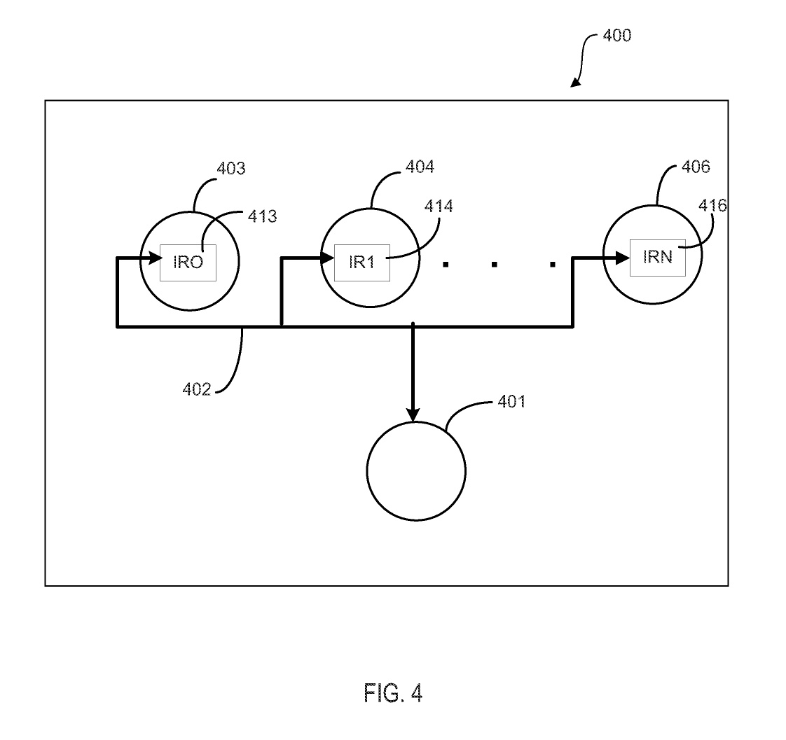

The embodiment of a processing system uses a special monitoring bus to read and write the content of any lower level processing instruction register. FIG. 4 is a block diagram 400 showing SyncP 401 connected to N lower level processors 403, 404 through 406 using a special bus 402.

Bus 402 includes an Address bus 402a that defines which instruction register of N lower level processors 403, 404 through 406 that SyncP 401 wants to access. Address bus 402a has log_{N} number of wires, for N=32, address bus 402a has only 5 address lines. Processor P0 403 instruction register, IR0 413, is accessed with address=0, processor P1 404, IR1 414, is accessed with address=1 . . . and processor PN 406, IRN 416, is accessed with address=N.

Bus 402 also includes a Data bus 402d which includes the contents of the accessed low level instruction register, for 64 bit instructions, data bus 402d width is 64 bit. SyncP 401 when reading the data from an accessed instruction register will compare its value with the value of an instruction code. If the value matches the code of an instruction that is related to synchronization as: request to access shared variable X, then SyncP 401 could decide to grant this request by writing in the accessed instruction register a special instruction that allows low level processor 403, 404 through 406 to have the right to access the shared variable.

Bus 402 also includes a Control line (402c) for Read/Write to low level processors 403, 404 through 406 instruction registers 413, 414 through 416 respectively. This is one bit line, when its value=0, SyncP 401 performs a READ, when the value=1 SyncP 401 performs a WRITE.

The address mapping of lower level processors 403, 404 through 406 instruction registers 413, 414 through 416 does not need to start at the SyncP 401 address 0 in its data memory Map. If we need to map it to a higher address, then a higher address line of SyncP 401 is set to 1 when accessing instruction registers 413, 414 through 416.

For example if we ignore A10, when accessing instruction registers 413, 414 through 416, then the starting address to access IR0 on data memory of SyncP 401 will be either 0 or 1024.

It is important to note that memory locations for instruction registers 413, 414 through 416 are accessed at the processor speed because they have a speed of instruction registers of lower level processors 403, 404 through 406 and they do not cost any physical space or power consumption to the system.

Instructions used to access lower level processors 403, 404 through 406 IR 413, 414 through 416 include:
LOAD R4, 1024(R0); • read instruction register 413 of P0 403 assuming IR 413 of P0 403 maps to location 1024
STORE R7, 1028(R0); • write to instruction register 414 of P1 404 assuming its IR 414 maps to location 1028

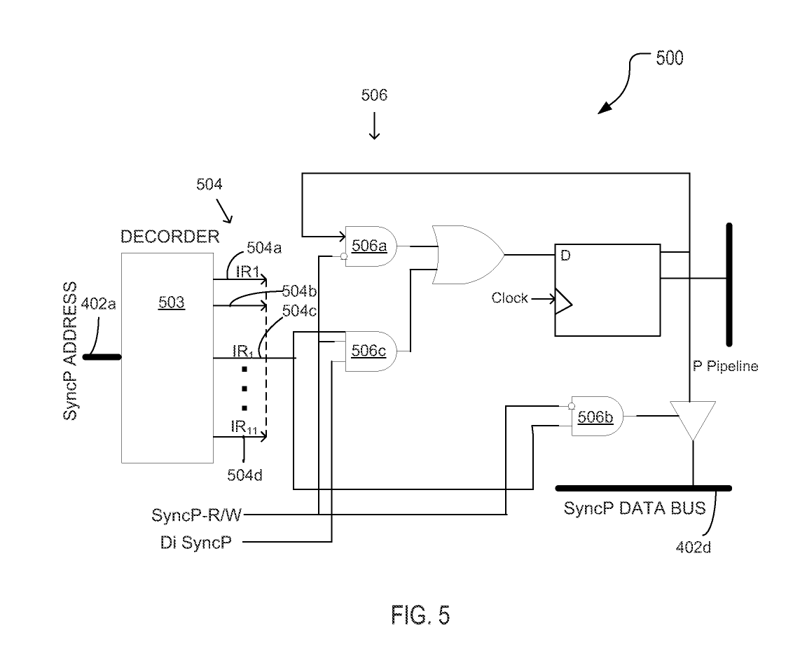

The load instruction transfers the value of memory location at 1024+ content of R0 to the SyncP 401 register R4. The value of R0 is normally set to 0, and 1024 is the starting address of mapping the lower level processors 403, 404 through 406 instruction registers 413, 414 through 416. In this example, address bus 402a in FIG. 5 will be set to 1024, data bus 402d will have the value of IR of P0, and control bus 402c will have READ/WRITE=0 for a read.

The store instruction allows SyncP 401 to write to P1 404 instruction register 414 the value set in SyncP 401 register R7. This value might be an instruction to grant the right to access a shared variable X. In this example, address bus 402a in FIG. 5 will be set to 1028, data bus 402d will have the value of R7, and control bus 402c will have READ/WRITE=1 for a write.

FIG. 5 is a schematic diagram 500 showing detailed design of how SyncP 401 can access any lower level processor 403, 404 through 406 to read or write to its instruction register. The address from SyncP bus 402a is decoded by decoder 503 to select one instruction register 504a-d from the N instruction registers 504 of lower level processors 403, 404 through 406. Signal IRi 504c of decoder output is assumed to be active and the lower level processor 404 is accessed to read or write its instruction register 414. The Flip-Flop 506 is one bit of the accessed instruction register 414 of the lower level processor 404. On a LOAD instruction, the SyncP-R/W signal=0, and the upper AND gate 506a is enabled because the inverter is connect to signal SyncP_R/W=0. When gate 506a is enabled, the same instruction in the instruction register is maintained by writing its content back to each Flip-Flop. Also, on the read because the signal IRi is active, the lower AND gate 506b is enabled to allow the content of each Flip-Flop to pass through the tri-state buffer to SyncP Data bus 402d.

On a STORE operation, the signal IRi is active, and SyncP_R/W=1 allowing the middle AND 506c gate to be enabled and the data from the upper level SyncP “Di SyncP” stored in the Flip-Flop. This is a new instruction written by SyncP 401 to be executed by lower level processor 404.

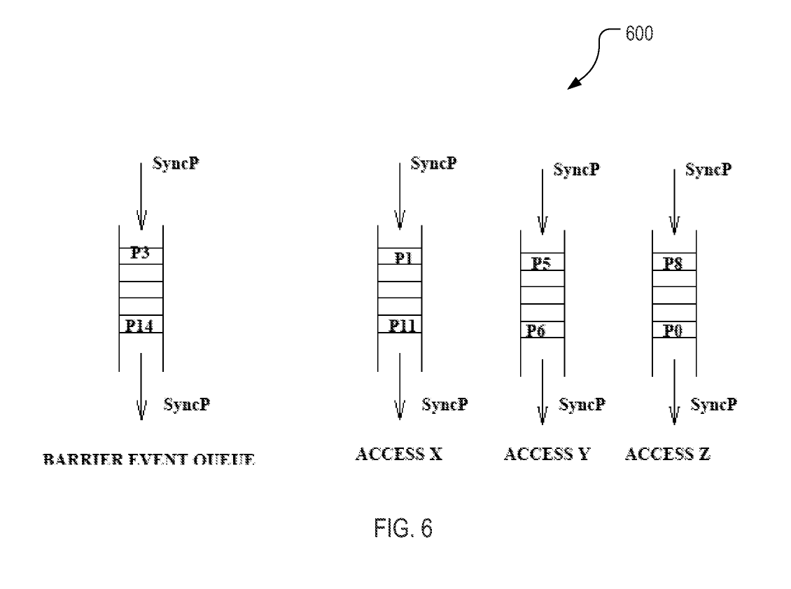

SyncP 401 can monitor the instructions of lower level processors 403, 404 through 406 and divide them into groups; each group competes for one shared variable. FIG. 6 is a diagram 600 showing SyncP 401 sorting different shared variables using queues. FIG. 6 shows the barrier event is shared between P3 and P14, variable X is shared between P1 and P11. Y is shared between P5 and P6.

The synchronization of multiple variables is achieved by the following steps:

1. SyncP 401 reads all instructions of the lower level processors 403, 404 through 406 in any order.

2. If SyncP 401 found a request from one of lower level processors 403, 404 through 406 to use a shared variable, it stores the requesting processor number in a queue that is dedicated to that variable. For example the ACCESS X queue is used for variable X. P11 is the first processor to be found requesting X (not arranged in the order of requesting).

3. SyncP 401 continues reading the instruction registers and sorts the different requests for using shared variables.

4. If another processor is requesting a shared variable that has a queue, for example X, the SyncP 401 adds the processor number to the X queue as P1 in FIG. 6.

5. For each queue, SyncP 401 uses the same code given above in the Synchronization of Multi-Level Processing section to grant the requesting processors. SyncP uses a superscalar architecture or in a single issue sequential code by combining the required code of each group. The performance of the sequential code is acceptable because the synchronization uses few instructions that execute at processor speed.

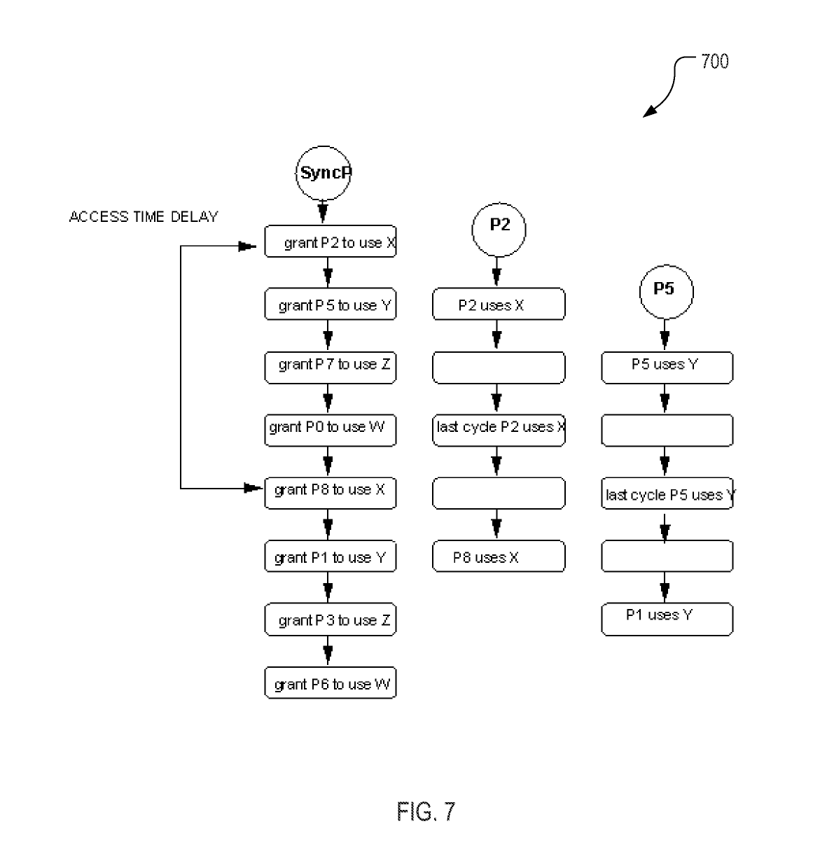

FIG. 7 is a flowchart 700 showing a method used to concurrently manage multiple shared variables. After SyncP 401 sorts the requests in different queues, it starts with granting accesses to each requesting processor. It uses interleaving of accesses to concurrently allow multiple lower level processors to access the different shared variables at the same time. SyncP 401 uses simple sequential code to grant these accesses. The interleaving makes it possible to overlap the time of synchronization used for different shared variables while SyncP is using a sequential code and a single bus to access lower level processors instructions.

As shown in FIG. 7 first column P2 initially gets the grant to use X first, in sequence then P5 gets a grant to use Y in series, the synchronization times of accessing X and Y are overlapped and occur in parallel. When P2 finishes using X, it asserts the halt instruction which is read by SyncP 401 and immediately grants P8 the right to use X and also allows P2 to continue. In this figure, It is assumed that P2 and P8 are sharing X and both are requesting to X at the same time, when P2 uses X, P8 is halted until SyncP 401 gives it a grant to use X. In a similar manner P1 and P5 share Y and P7 and P3 share Z.

Lower level processors 403, 404 through 406 use a special Halt instruction when requesting to use or finish from using a shared variable. One of lower level processor's 403, 404 through 406 pipeline control circuit uses a state machine that causes the control circuit to stay in the same state when executing the Halt instruction causing the pipeline to halt. The pipeline continues its normal execution of instructions only when the halt instruction is removed by SyncP 401 writing to it a different instruction.

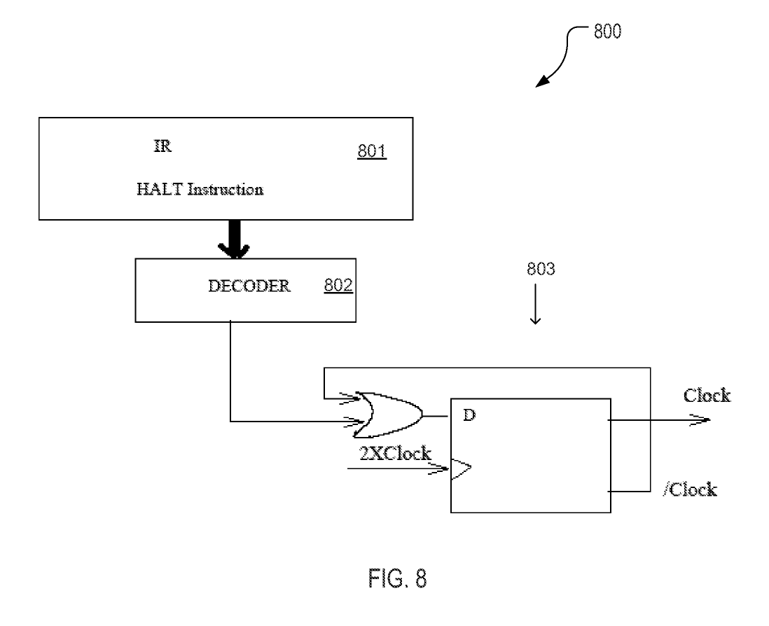

FIG. 8 is a block diagram 800 of how one of lower level processors 403, 404 through 406 halts its execution by stretching the clock as a result of the halt instruction. The instruction register 801 contains the halt instruction, and then the decoder output signal becomes active and equal 1. The OR gate connected to the decoder 802 output will generate an output=1, forcing the Flip-Flop 803 output and Clock signal to equal 1. If the instruction is not a halt, the output of the Flip-Flop 803 toggles every 2× clock due to the feedback from the invert of Clock signal generating the required Clock at ½ the frequency of Flip-Flop 803 2× clock.

The power consumption in any circuit is proportional to the frequency of clock. The increased speed of new processors causes a problem in the design of these processors due to difficulties in managing the power inside the chip. Halting the processor while waiting for the grant helps in reducing the power. Conventional processors use locks and they continuously spin and consume power waiting for the lock to be free.

It is important to note that this feature of halting the pipeline by stretching its clock could also be used as a feature for any conventional processor.

Modern processors provide SIMD instruction sets to improve performance of vector operations. For example, Intel's Nehalem®, and Intel's Xeon® processors support SSE (Streaming SIMD Extensions) instruction set, which provide 128-bit registers that can hold four 32-bit variables.

The SSE extension complicates the architecture because of adding extra instructions to ISA. It adds extra pipeline stages and uses over head of extra instructions to support packing and unpacking data to registers.

Multi-level processing offers SIMD feature with no added complexity to the design. The ability of SyncP 401 to write to the instruction registers of lower level processors allows it to write one instruction to all of the instruction registers of lower processors 403, 404 through 406 by enabling the write signal to all instruction registers. SIMD is implemented in the Multi-Level processing as a multiple same instruction working on multiple different data, which is a different and effective method in implementing SIMD. Each lower level processor does not know that the instruction is SIMD; therefore, there is no need to add complexity to support it as compared to Intel SSE implementation. There is also no need for packing or unpacking data to registers, because it uses the same registers accessed by the conventional instructions as its data. In Multi-Level, it is possible to pack multiple data elements to one register in lower level processors. It will make eight lower level processors using 128 bit registers, if packing 4 elements in each register producing a vector length of 32 compared to only 4 for Intel SSE. If 32 processors packing data of 16 bits elements, they will produce a vector length of 32×8=256 elements executed in one cycle operation. Vector processors that supported long vectors like CRAY are very costly to build.

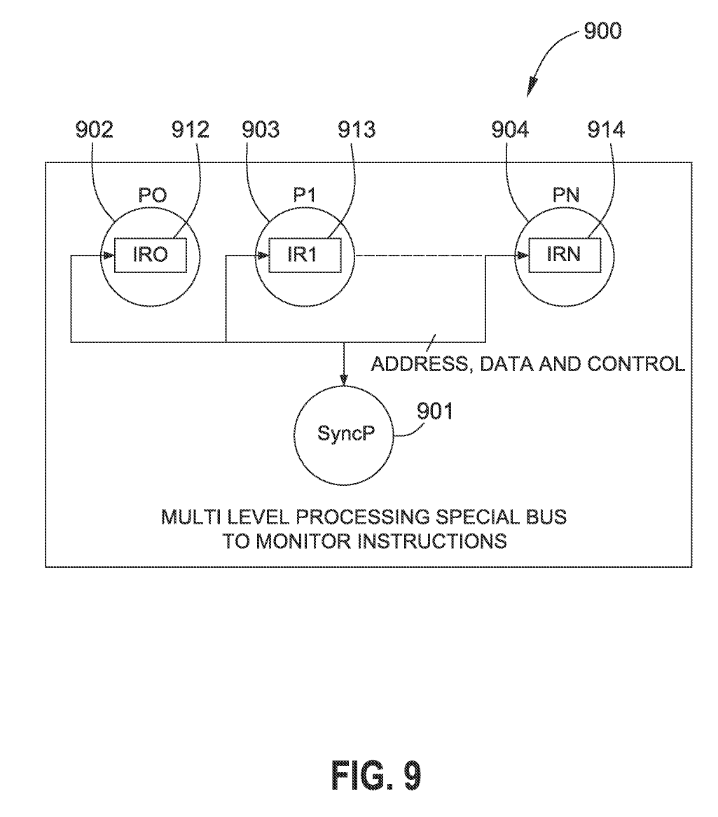

FIG. 9 is a block diagram 900 for SyncP 901 writing to all lower level processors 902, 903 through 904 instruction registers 912, 913 through 914 instruction ADDV R1, R2, R3. This instruction when is executed by each lower level processor 902, 903 through 904 performs an add to the content of R2 and R3 in each processor registers 902, 903 through 904, however R2 and R3 in each of processors 902, 903 through 904 holds a value of different elements in the vector array. For example if we are adding vector A to Vector B, first a LOADV R2, 0(R5) instruction is executed and R5 in each of lower level processor 902, 903 through 904 is set to be the address of different elements in array A. Executing this SIMD instruction transfers elements of A to the R2 registers of the different processors.

The following code explains a vector operation performed using SIMD in multi-level processing:
ADDI R5, R0, #i+1000; • Initialize R5 to point to element i in A[i]
ADDI R6, R0, #i+10000; • Initialize R6 to point to element i in B[i]
ADDI R7, R0, #100,000; • Initialize R7 to point to element i in C[i]
LOADV R8, 0(R5); • R8=load vector A[ ] or portion of it to R8 registers of different processors
LOADV R9, 0(R6); • R9=load vector B[ ] or portion of it to R8 registers of different processors
ADDV R10, R8, R9; • Add elements of A to B and store results in R10 of each processor as a vector
STOREV R10, 0(R7); • Store R10 registers of different processors to C or portion of it

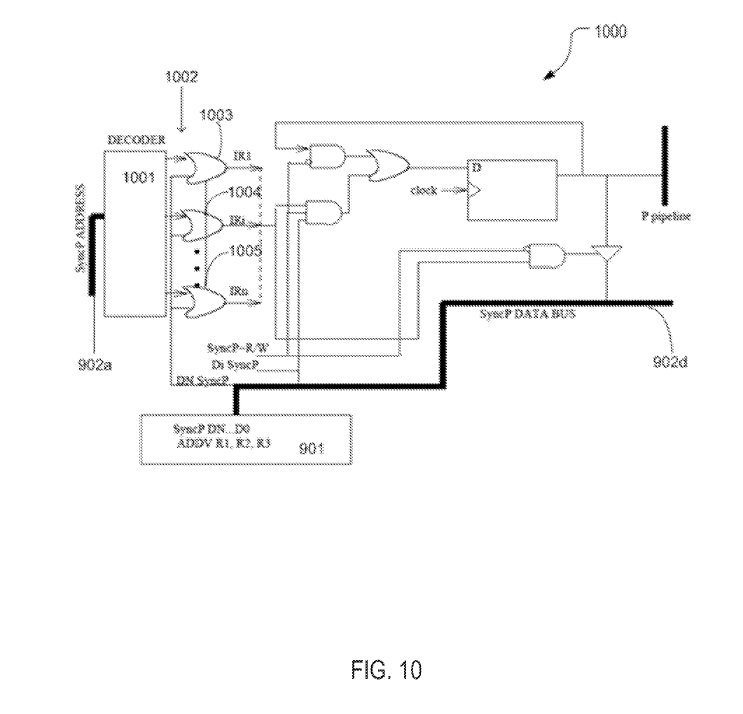

SyncP 901 uses its data bus 902d shown in FIG. 10 to write to the instruction registers 912, 913 through 914 of all lower level processors 902, 903 through 904 respectively by making the most significant bit of its data bus DN equal to 1. For any other instruction that is not SIMD, DN bit is set to zero.

FIG. 10 is a block diagram 1000 showing an implementation of SIMD in the multi-level processing. All of the outputs 1002 of the decoder 1001 that are used to select one of the instruction registers are connected to OR gates 1003, 1004 through 1005 with DN as the other input. The outputs of all OR gates for all the instruction registers of all lower level processors are set to 1 as a result of DN=1. Returning to FIG. 9 All of the input data DN-1 to D0 from SyncP 901 are written simultaneously to instruction registers 912, 913 through 914 of all lower level processors 902, 903 through 904 when R/W=1 as explained before. Then each lower level processor 902, 903 through 904 starts to execute the same instruction that was written in their instruction registers in parallel. The figure shows the executed instruction adds content of R2 to R3 and stores result in R1 as vectors.

Elements in R2 and R3 of each processor 902, 903 through 904 form a vector of elements, which could be loaded from the memory with yet another LOADDV SIMD instruction.

There is another important feature for the multi-level processing that allows sequential instructions to generate multiple instructions working in multiple data streams. SyncP 901 divides its data into fields then each field is used as an address to a ROM that stores a list of decoded instructions ready to be executed. Using micro code ROM eliminates the need for a decode stage to keep pipeline without stall as in Intel's Pentium4®.

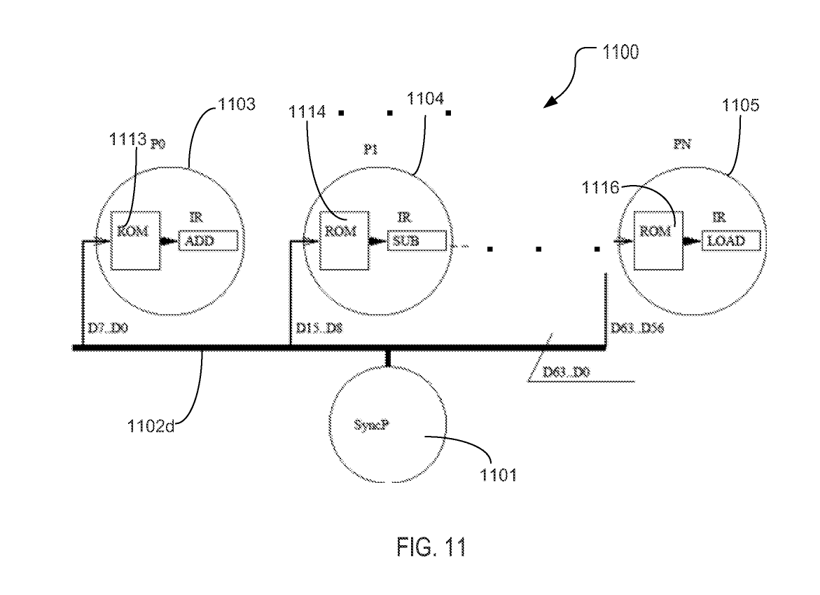

FIG. 11 is a block diagram 1100 showing a system that supports SI>MIMD. SyncP 1101 data bus 1102d is assumed to be 64 bits and is divided to eight separate fields each one used as an address to access a ROM 1113, 1114 through 1116 for the corresponding lower level processor 1103, 1104 through 1105 respectively. In this example P0 1103 uses D7 . . . D0 of SyncP data to address its ROM 1113 that has 256 locations. If SyncP 1101 has a longer data, each ROM 1113, 1114 through 1116 could have larger storage of coded instructions. A ten bit address will access 1024 different decoded instructions.

FIG. 11 also shows that SyncP 1101 data D7 to D0 is used as an address for P0 1103 ROM 1113 that produced an ADD instruction to P0. SyncP data D15 to D8 is an address to P1 1114 ROM 1114 that produced a SUB instruction. As shown in FIG. 11, these are different instructions executed in parallel resulted from SyncP 1101 executing one instruction that uses it as multiple addresses to access multiple different instructions from number of ROMs 1113, 1114 through 1116.

There are a plurality of advantages to this SI>MIMD method including:

1. Makes writing parallel code easy because it uses single sequential instructions to generate the parallel code for multiple processors 1103, 1104 through 1106.

2. Synchronization is not needed for the portion of code generated from single instruction.

3. Lower level processors 1103, 1104 through 1105 execute instructions directly from their ROM 1113, 1114 through 1116 respectively without the need to fetch them from cache or slow memory thus reduces power, and complexity.

4. Instructions are executed at processor speed from ROMs 1113, 1114 through 1116 which improves performance and bandwidth of instruction delivery to processors 1103, 1104 through 1105.

5. It could reduce or eliminate the need for costly and complicated instruction caches or instruction memory for lower level processors 1103, 1104 through 1106.

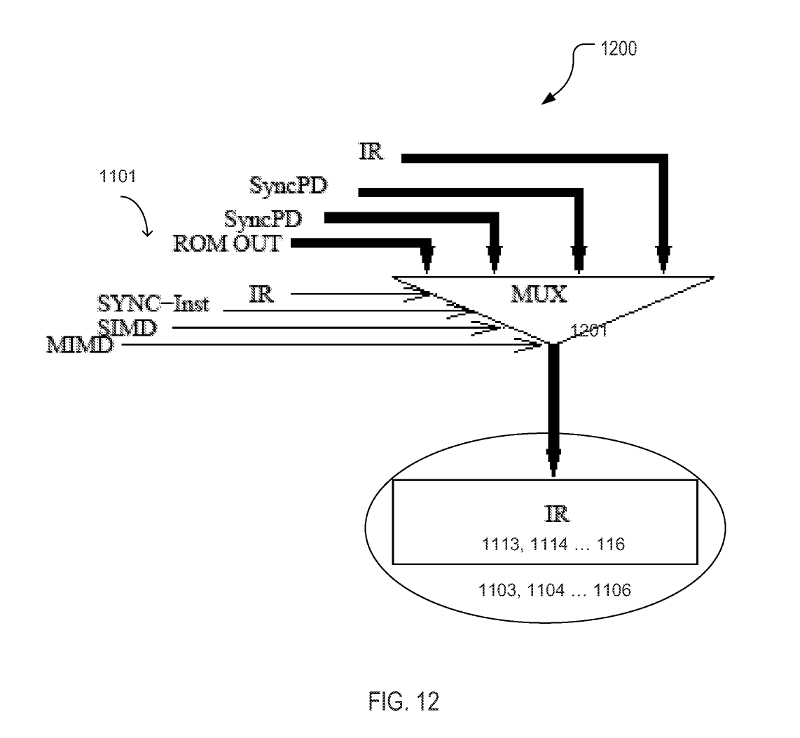

FIG. 12 is a diagram 1200 showing how SyncP 1101 controls the issuing of different instructions to lower level processors 1103, 1104 through 1106. The Multiplexer 1201 is used to select different type of instructions to IR for the lower processor 1103, 1104 through 1106 based on type of data supplied by SyncP 1101 to lower level processing. The select lines of multiplexer are connected to some of the data lines of SyncP 1101 and are controlled by the specific operation that SyncP 1101 performs. For example in SIMD, bit DN of SyncP 1101 is set to 1.

The following different multiplexer selections are:

1. Lower level processing keeps the same instruction in the instruction register if SyncP 1101 does not need to write and change the instruction. Multiplexer 1201 selects the content of same instruction register as input.

2. Multiplexer 1201 selects SyncPD 1101 first data input if it needs to write a halt or a grant instructions which are mainly used in synchronization.

3. Multiplexer 1201 selects SyncPD 1101 second data input if SyncP needs to perform SIMD. In this case the SyncP 1101 data is written to the instruction registers of all lower level processors.

4. Multiplexer 1201 selects the ROM OUT input if SyncP 1101 needs to perform SI>MIMD instruction.

Multi-level processing can extend the number of levels to three or more levels of lower level processors while executing code perform the duties of a SyncP to yet another lower level processor. The number of processors in the system will be N×N and the scalability of this system will be N×N. The reduced synchronization overhead achieved with having a higher level processor managing the synchronization of lower level processors will help in increasing the scalability of the system to N×N.

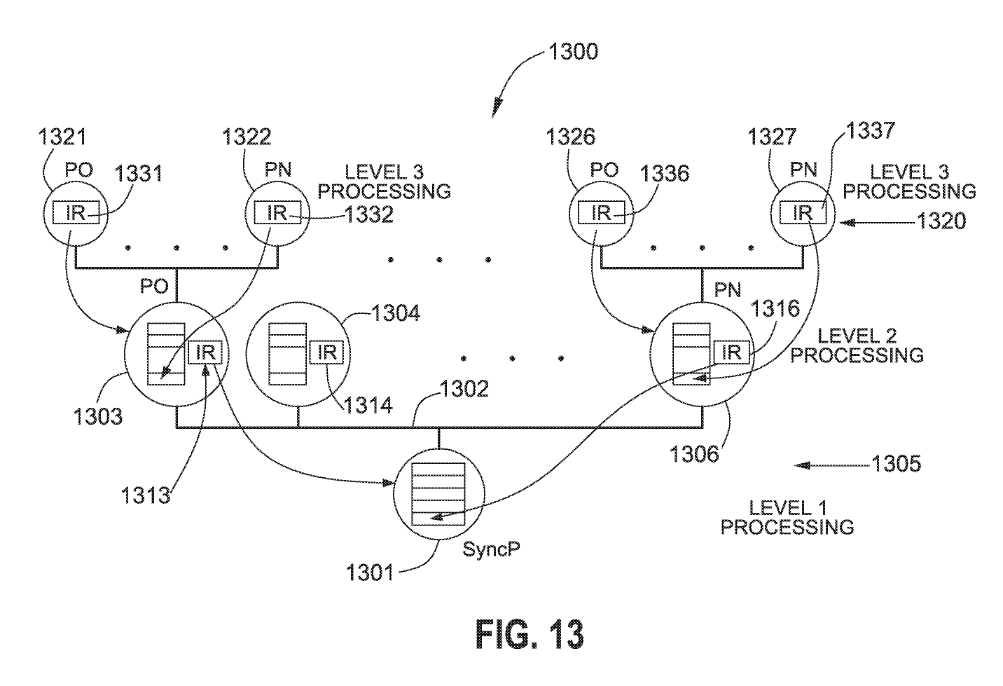

FIG. 13 is a block diagram 1300 showing three level processing. The first level processor SyncP 1301 maps all of instruction registers 1313, 1114 through 1116 of the second level processing 1305 processors 1303, 1304 through 1306 to its data memory and can read or write to them using the special bus 1302 as explained before.

Each processor 1303, 1304 through 1306 of the second level 1305 also could control a number of other lower level processors similar to the SyncP 1301 except these second level processors 1303, 1304 through 1306 also perform their ordinary processing operations. The second level processors 1303, 1304 through 1306 map the instruction registers 1331 through 1332 by second level processor 1303 and 1336 through 1337 by second level processor 1306 of the third level processors 1321 through 1322 by second level processor (1393 not in Fig) to their data memory to manage their synchronization. The managing of lower level processors 1321 through 1327 requires minimum support because it only needs one cycle to halt or grant lower level processors 1321 through 1327 at processor speed.

It is also possible to implement some of the above mentioned features for the three levels of processing including SIMD, SI>MIMD.

A higher level processor controlling a number of lower level processors by reading and writing to their instruction registers without any involvements from them reduces the synchronization overhead from thousands of processor cycles to few cycles. Example embodiments may also have many other important advantages including the ability to reduce power by halting these processors while waiting to access shared variables.

The higher level processor is able to convert simple sequential instructions to parallel instructions making it easier to write parallel software. Vector operations could be effectively supported for long vectors with simple SIMD implementation. It is also able to extend multi-level processing to other levels allowing unlimited scalability.

The embodiments shown are exemplary only the invention being defined by the attached claims only.

1. A processor for processing data comprising: a plurality of lower level processors having a register storing instructions for processing data; and,
an upper level processor including a memory for processing data connected to said first level processors, wherein said upper level processor controls at least a portion of the operation of said plurality of second level processors.

2. A processor as in claim 1, wherein said upper level processor maps a portion of each of said lower level processors instruction into said upper level processors memory.

3. A processor as in claim 2, wherein said upper level processor maps all of said lower level processors instructions into memory.

4. A processor as in claim 1, further comprising a bus connected between said upper level processor and each of said lower level processors.

5. A processor as in claim 3, wherein a separate memory area is allocated for each of said lower level processors.

6. A processor as in claim 1, wherein said upper level processor is enabled to control the instructions said lower level processors execute and the time to execute said instructions.

7. A processor as in claim 6, wherein said upper level processor is enabled to inject instructions into said lower level processors to control the instructions said lower level processors execute and the time to execute said instructions.

8. A processor as in claim 7, wherein said injection of instructions is based upon synchronization requirements.

9. A processor as in claim 7, wherein said instruction injected is a halt instruction.

10. A processor as in claim 1, wherein said upper level processor is enabled to control the clock speed of each of said lower level processors.

11. A processor as in claim 1, wherein said upper level processor is enabled to provide an identical variable to multiple lower level processors.

12. A processor as in claim 2, wherein said bus is further comprising an address bus for defining which address register of said lower level processors said upper level processor addresses;
a data bus for including the contents of accessed lower processor registers; and,
a control line for controlling Read/Write to said lower level processors.

13. A processor as in claim 12, wherein said data buss has a width of 64 bits and said control line has a one bit value.

14. A method for synchronizing different processors in a multi-level processor comprising the steps of;
mapping the instructions of lower level processors registers into the memory of said upper level processor; and,
injecting instructions from said upper level processor into lower level processors for synchronizing them.

15. The method for synchronizing different processors in a multi-level processor as in claim 14 further comprising the step of controlling the clock speed of each lower level processor by an upper level processor.

16. The method for synchronizing different processors in a multi-level processor as in claim 14 wherein said injecting step injects a Halt instruction.

17. The method for synchronizing different processors in a multi-level processor as in claim 15 wherein said clock speed is controlled by stretching the clock cycle of the lower level processor desired to be slowed down.

18. The method for synchronizing different processors in a multi-level processor as in claim 14 wherein the method further comprises removing the Halt instruction to said lower level processor once critical code is executed.

19. The method for synchronizing different processors in a multi-level processor as in claim 14 wherein the method further comprises removing the Halt instruction to said lower level processor once execution of a shared variable has occurred.

20. The method for synchronizing different processors in a multi-level processor as in claim 17 wherein the method of stretching the clock cycle is by the use of a flip flop.

21. A system for processing data comprising: a plurality of lower level processors having a register storing instructions for processing data;
an upper level processor including a memory for processing data connected to said first level processors, wherein said upper level processor controls at least a portion of the operation of said plurality of second level processors; and,
an input for inputting data and, an output for outputting data.

22. A system as in claim 21, wherein said upper level processor maps a portion of each of said lower level processors instructions into said upper level processors memory.

23. A system as in claim 21, wherein said upper level processor maps all of said lower level processors instructions into memory.

24. A system as in claim 21, further comprising a bus connected between said upper level processor and each of said lower level processors.

25. A system as in claim 23, wherein a separate memory area is allocated for each of said lower level processors.

26. A system as in claim 21, wherein said upper level processor is enabled to control the instructions said lower level processors execute and the time to execute said instructions.

27. A system as in claim 26, wherein said upper level processor is enabled to inject instructions into said lower level processors to control the instructions said lower level processors execute and the time to execute said instructions.

28. A system as in claim 27, wherein said injection of instructions is based upon synchronization requirements.

29. A system as in claim 27, wherein said instruction injected is a halt instruction.

30. A system as in claim 21, wherein said upper level processor is enabled to control the clock speed of each of said lower level processors.

31. A system as in claim 21, wherein said upper level processor is enabled to provide identical instructions to multiple lower level processors.

32. A system as in claim 21, wherein said bus is further comprising an address bus for defining which address register of said lower level processors said upper level processor addresses; and, a data bus for including the contents of accessed lower processor registers; and, a control line for controlling Read/Write to said lower level processors.

33. A system as in claim 32, wherein said data buss has a width of 64 bits and said control line has a one bit value.

34. A processor including a comprising: an execution unit for processing instructions; and, a clock connected to said execution unit for timing the processing of instructions; and, wherein the processor has the ability to stretch the clock cycle for allowing reduced power consumption.

35. A processor as in claim 34, further comprising circuitry to stretch the clock frequency by halving the clock frequency.

36. A processor as in claim 34, wherein said circuitry comprises a flip flop.

37. A processor as in claim 34, wherein the clock cycle is stretched upon receipt of a Halt instruction.

38. A Processor comprising: an upper level processor with a ROM; and, a plurality of lower level processors each having their own ROM, wherein a single instruction in the ROM of said upper level processor is divided into index multiple ROM in said lower level processors for generating multiple and different independent parallel instructions from the one instruction issued by the higher level processor.
